(19) United States
(12) Patent Application Publication
(10) Pub. No.: US 2003/0083882 A1
(43) Pub. Date: May 1, 2003

(54) Method and apparatus for incorporating application logic into a voice responsive system

(76) Inventors: Roland J. Schemers III, Redwood City, CA (US); Ross Dargahi, Mountain View, CA (US)

Correspondence Address: BLAKELY SOKOLOFF TAYLOR & ZAFMAN/PDC, 12400 WILSHIRE BOULEVARD, SEVENTH FLOOR, LOS ANGELES, CA, 90025, US

(21) Appl. No.: 09/859,107

(22) Filed: May 14, 2001

(51) Int. Cl. G10L 21/00

(52) U.S. Cl. 704/270.1

(57) ABSTRACT

A method and apparatus for incorporating application logic into a voice responsive system are described. The system includes a voice server to receive a request from a voice browser in response to user input. The voice server responds by accessing a VXML based call flow document to initiate a call flow. The call flow document may contain standard VXML tags as well as VXML extension elements. The VXML extension elements provide logic for the call flow, either explicitly or by referencing separate objects or functions. The voice server includes an engine to parse the call flow document, including identifying the VXML extension elements and other tags, and to invoke the appropriate code to execute the application logic based on the VXML extension elements. This approach allows application logic provided by “backend” servers to be included in a call flow.

A portion of the disclosure of this patent document contains material which is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### FIELD OF THE INVENTION

The present invention pertains to voice responsive processing systems. More particularly, the present invention relates to a method and apparatus for incorporating application logic into a voice responsive processing system.

### BACKGROUND OF THE INVENTION

Interactive Voice Response (IVR) systems may be defined to include automated processing systems capable of carrying out operations in response to the human voice or dual tone multi-frequency (DTMF) tones (a.k.a. “touchtones”). A simple example of such a system is a voice-activated dialer, which responds to a user speaking the name of a person to be called, by automatically dialing the appropriate telephone number. As a more sophisticated example, rapid progress is being made in the development of a “voice web”. The voice web will be analogous to (and possibly integrated with) the well-known World Wide Web. However, the information maintained on the voice web will be primarily in audible form, and users will access the information using speech or DTMF tones. More specifically, a user will access the voice web using a telephone or other standard audio equipment to operate a device known as a voice browser. The voice browser will respond to the user's spoken or keyed requests to access information stored on a remote processing system, and will provide the information to the user in audible form, such as in the form of recorded or synthesized speech.

Although the telephone is a common channel through which users access IVR systems, such systems can also be accessed through other types of communication channels, such as by using a computer connected to the Internet. Nonetheless, a session between a user and a voice responsive system may be referred to as a “call” regardless of the type of communication channel used, and the sequence or logical structure of the call is often referred to as the “call flow”. A call flow normally includes application logic which defines the various conditions, decisions, branches, and other higher-level operations (i.e., the “flow” of the call) as well as various presentation features (i.e., the input/output characteristics of the call).

It is desirable to allow the individuals and enterprises who maintain and operate IVR systems to create or customize their call flows. With current technology, call flow customization requires programming by development engineers. This results in additional cost in terms of both time and money for development, quality assurance (QA), and release phases. Thus, if an enterprise wishes to modify some aspect of the call flow (e.g., to add a menu item), engineering development effort is normally required.

With the advent of voice extensible markup language (VXML) and VXML browsers, it has become possible to create custom voice applications for IVR systems. VXML is a voice based analogue to hypertext markup language (HTML), and a VXML browser is a voice based analogue to an HTML browser, such as Microsoft Internet Explorer or Netscape Navigator. Like HTML, however, VXML is essentially a presentation language. That is, it does not provide the necessary constructs for building rich applications, such as unified communication or unified messaging applications. For example, when using such applications, a user might wish to retrieve and listen to his new voicemail messages. To do this, he typically has to first proceed through an authentication stage and then be presented with a list of new voicemails. From this list, he may select messages to be played back, messages to be saved, and messages to be deleted. While VXML is able to provide the presentation aspects of this interaction (e.g., prompts and a menu of choices mapped to DTMF keys of voice commands), it is unable to represent the sometimes-complex application logic required for managing interactions with external systems, such as directories, message stores, and personal information management (PIM) servers.

Consequently, the application logic of call flows has traditionally been encoded in a procedural language such as Perl or C. As a result, if an enterprise wishes to modify some aspect of the call flow, modification of that code is normally required, which involves engineering development and QA effort, and therefore, additional cost. The current approach, therefore, is not conducive to creation or customization of call flows for IVR systems that have already been deployed.

### SUMMARY OF THE INVENTION

The present invention includes a method and apparatus to create a VXML based call flow document, for use by a server in a voice responsive system, to define a call flow. A VXML extension element is incorporated into the call flow document to provide application logic for the call flow. The call flow document is stored in the voice responsive system.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of an IVR system that incorporates logic into a call flow using VXML extensions;

FIG. 2 is a block diagram showing the elements of the engine;

FIGS. 3A and 3B collectively form a flow diagram showing an overall process for incorporating logic into a call flow using VXML extensions;

FIG. 4 is a flow diagram showing the processing of an element in a call flow document; and

FIG. 5 is a block diagram of a processing system that can be used to implement one or more of the elements shown in FIG. 1.

### DETAILED DESCRIPTION

A method and apparatus for using VXML extensions to incorporate application logic into a voice responsive system are described. Note that in this description, references to “one embodiment” or “an embodiment” mean that the feature being referred to is included in at least one embodiment of the present invention. Further, separate references to “one embodiment” in this description do not necessarily refer to the same embodiment; however, neither are such embodiments mutually exclusive, unless so stated and except as will be readily apparent to those skilled in the art. Thus, the present invention can include any variety of combinations and/or i of the embodiments described herein.

### I. Overview

As described in greater detail below, the solution described herein includes a call flow language which extends VXML with a set of custom elements. These elements provide the necessary expressiveness for interacting with middle tier servers, as well as expressing the necessary application logic for a voice application. The set of elements is easily and canonically extensible; that is, new elements can easily be added to a running system on-the-fly.

The solution also provides a set of objects and functions accessible from this call flow language, that provide aggregate useful capabilities (e.g. playing a folder summary of new emails, faxes, and voicemails) and that also export the ability to access key system functionality, such as account profile information, voice mail messages, personal information management data (e.g. calendar and address book). The set of functions and objects is also easily extensible, such that new functions and objects can be added on-the-fly. In addition, the solution includes a server framework for transparently managing such things as user sessions.

The IVR system described herein includes a voice server to receive a request from a voice browser in response to user input. The voice server responds by accessing a VXML based call flow document to initiate a call flow. The call flow document may contain standard VXML tags as well as VXML extension elements. The VXML extension elements can be used to provide application logic for the call flow, either explicitly or by referencing separate objects or functions containing the logic. The voice server includes an engine to parse the call flow document, including identifying the VXML extension elements and other tags, and to invoke appropriate code to execute the call flow logic based on the VXML extension elements. This approach allows the inclusion of application logic provided by “backend” servers in a call flow.

### II. IVR System and Process

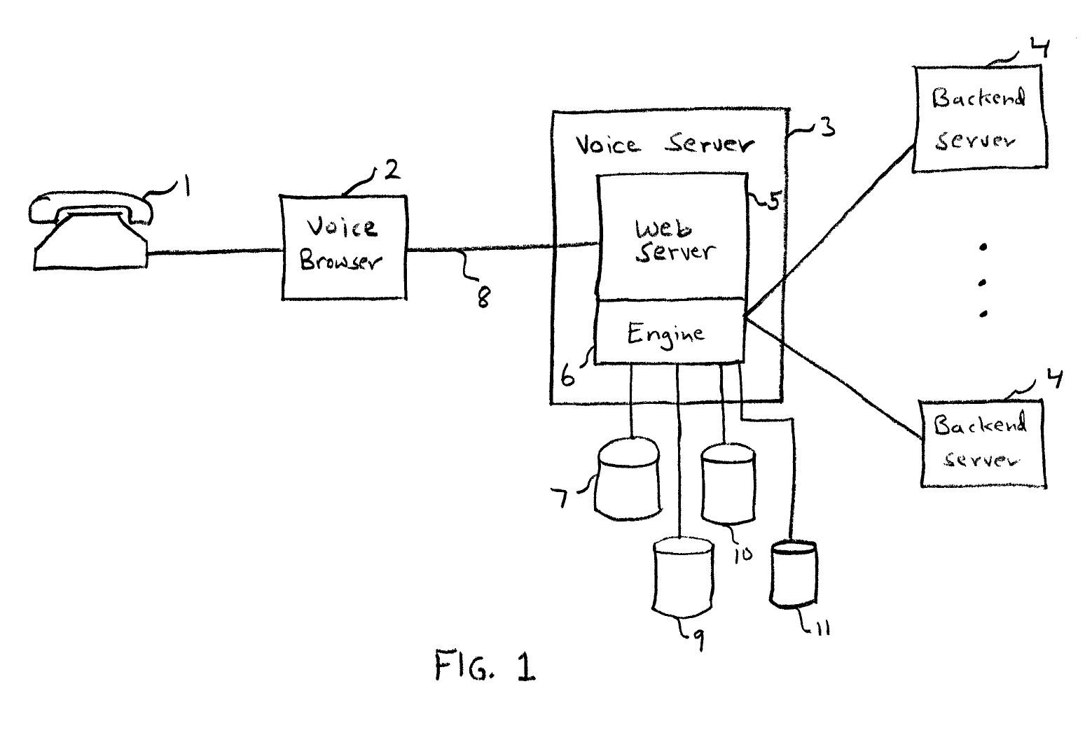

Refer now to FIG. 1, which illustrates an example of an IVR system that incorporates logic into a call flow using VXML extensions, in accordance with the present invention. The system includes a voice browser 2, and an audio input/output (I/O) interface 1 by which the user accesses a voice browser 2. The audio I/O interface 1 may be a conventional or cellular telephone, as shown, such that the user may access the voice browser 2 over a conventional or wireless telephone network by dialing a predetermined telephone number. In alternative embodiments, however, the user can access the voice browser 2 through other types of communication channels, such as the Internet or a corporate intranet (using, for example, IP telephony and/or Voice-over-IP).

The voice browser 2 operates in a manner that is analogous to a conventional HTML based web browser, except that it is responsive to voice input from the user and is used to access hyperlinked audio content (as opposed to text, graphics, or video). The voice browser 2 may be implemented in a conventional processing system, such as an AS5300 universal access server from Cisco Systems of San Jose, Calif.

The system also includes a voice server 3. The voice server 3 provides VXML based content to the voice browser 2 over a standard hypertext transport protocol (HTTP) interface 8, in response to requests from the voice browser 2 (which requests are transmitted in response to voice input from the user). The system also includes one or more VXML based call flow documents 7, which may be (but do not have to be) stored within the voice server 3 in one or more conventional mass storage devices. The call flow documents 7 define the call flow and are accessed by the voice server 3 in response to an initial request from the voice browser 2, to control the call. Hence, the call flow documents 7 are at least a part of the “content” which a user accesses through the voice browser 2 and the voice server 3. The call flow documents 7 include both standard VXML as well as various new elements (tags) defined herein, which are referred to as VXML extension elements or custom elements. The VXML extension elements are used to incorporate application logic into the call flow and are described further below.

In one embodiment, the voice server 3 includes a standard web server 5 (e.g., Apache) and a VXML extension engine (or simply “engine”) 6. The engine 6 parses and interprets the extended VXML call flow documents. It has the ability to recognize standard VXML tags as well as the extension elements, and includes code for implementing the logic represented by those elements. In one embodiment, the engine 6 includes a conventional, “off-the-shelf” PHP (Hypertext Preprocessor) scripting language interpreter. In one embodiment, the engine 6 also includes additional code, which implements application logic represented by custom elements, as well as various functions and objects (mentioned above and described further below) which are invoked using custom elements. The additional code may be written in PHP scripting language, Perl, and/or C programming language, for example. Referring still to FIG. 1, additional elements, functions and objects are stored in external element files 9, function files 10, and object files 11, respectively, for implementing application logic for a call flow.

The system also includes one or more backend servers 4. The backend servers 4 may contain application logic as well as other content accessible to the user via the voice browser 2 and voice server 3. The VXML extension elements may be used to invoke and/or interact with application logic residing on the backend servers 4. As one example, a VXML extension element in a call flow document 7 may be used to invoke a user login/ authentication operation carried out by one of the backend servers 4.

An important advantage of this approach is that a call flow can be modified on-the-fly in a running system, simply by modifying one or more of the stored call flow documents 7.

An important service that the voice server 3 provides is session management. As the user interacts with the system during a VXML session, certain application state must be captured and managed for the lifetime of the session. For example, if as part of a call flow the user “logs in”—for example to retrieve voice mail—the system must keep track of the user's authentication token and the fact that the user has logged in. This tracking and management is done by the voice server 3 and is hidden from the call flow developer.

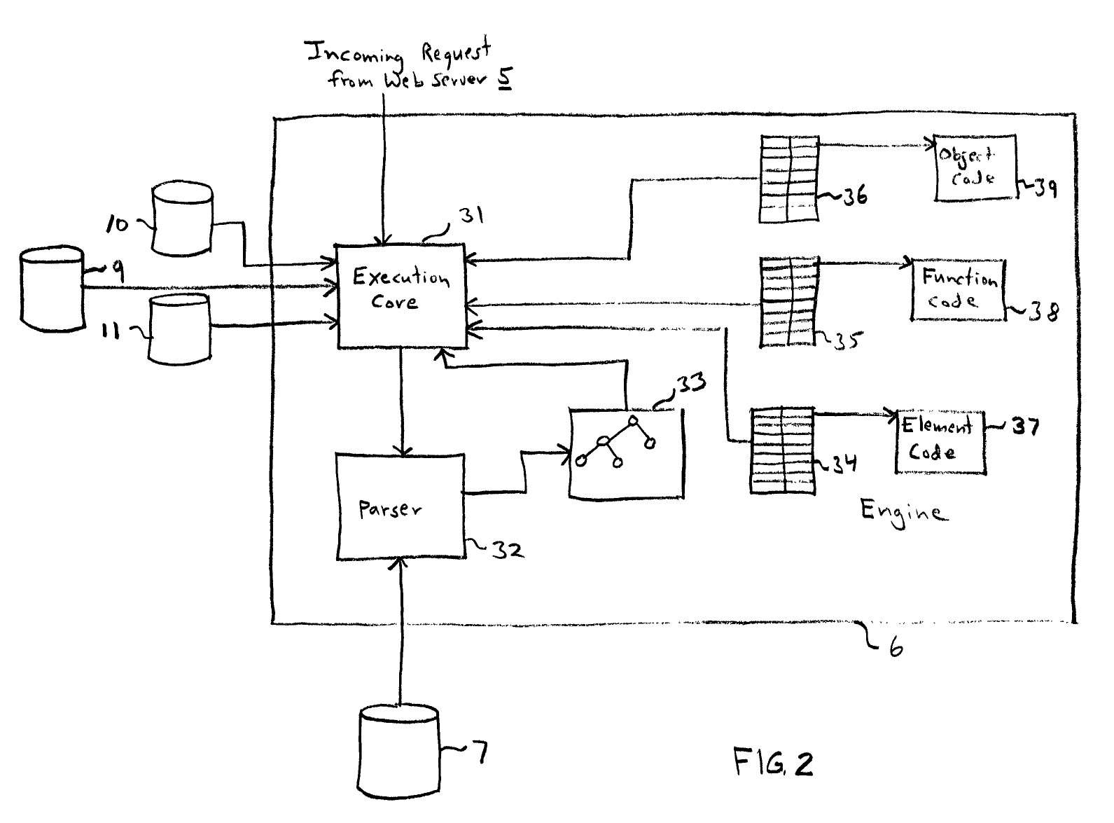

FIG. 2 shows the elements of the VXML extension engine 6, according to one embodiment. As shown, the engine 6 includes an execution core 31 and a parser 32. The parser 32 is responsible for parsing call flow documents 7. The result of parsing a call flow document is a parse tree 33, which indicates to the execution core 31 the sequence in which the elements of the call flow document should be processed. The execution core 31 executes a parsed call flow document by invoking the element code, functions and/or objects represented by the elements in the document. The element code, functions and objects may be internal to the engine 6, as is the case with internal element code 37, internal function code 38, and internal object code 39. Tables 34, 35 and 36 contain mappings used by the execution core 31 to determine the storage locations of the internal element code 37, internal function code 38 and internal object code 39, respectively, based on the referencing extension elements. Other element code, objects, and functions are stored in external element files 9, function files 10, and object files 11.

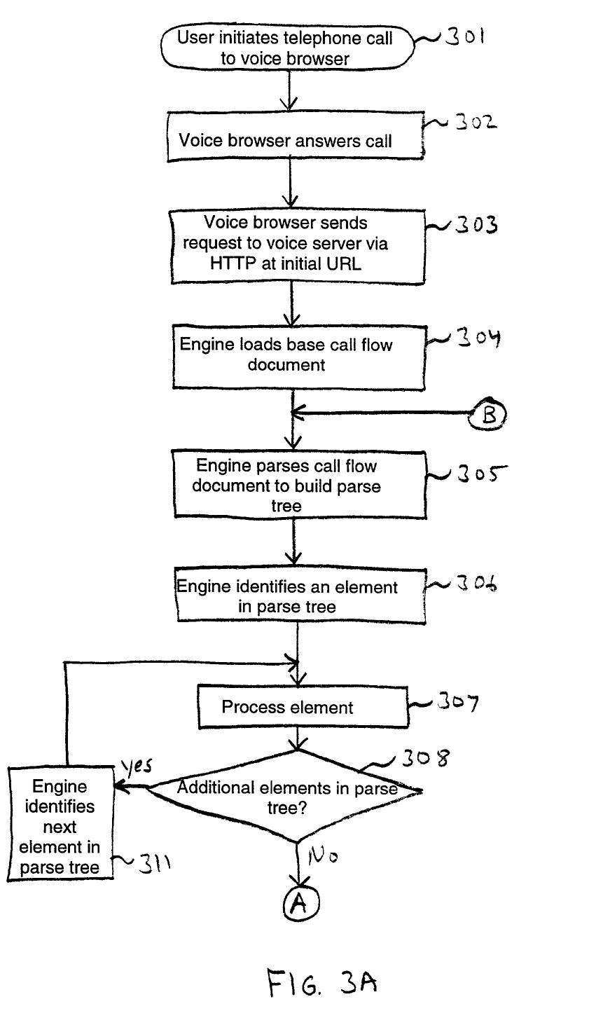

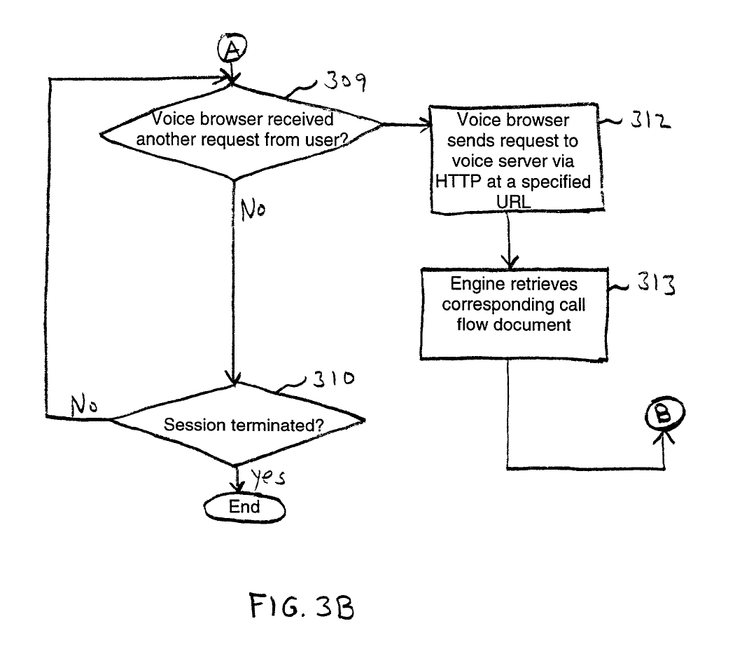

FIGS. 3A and 3B collectively show an overall process that may be executed by the system of FIG. 1 during a call, in accordance with the present invention. This process will now be described, also with reference to FIGS. 1 and 2. Initially, at block 301 a user initiates a call to the voice browser 2. The voice browser 2 answers the call at block 302 and, at block 303, sends an HTTP request to the voice server 3 specifying an initial uniform resource locator (URL). At block 304, the VXML extension engine 6 identifies and loads the base (main) call flow document of the set of call flow documents 7, based on the URL specified by the browser 2. Note that a call flow can be implemented within a single call flow document or within multiple call flow documents. The engine 6 then parses the call flow document into a parse tree at block 305. At block 306, the engine 6 uses the parse tree to identify the first element (tag) in the call flow document, and at block 307 the engine processes the element in an appropriate manner, as described below in greater detail.

After processing the element, at block 308 the engine 6 determines from the parse tree whether there are additional elements to be processed in the call flow document. If so, the engine 6 identifies the next element at block 311, and the process then continues from block 307 (discussed above). If all of the elements in the call flow document have been processed, then the process continues from block 309. At block 309, if the voice browser 2 has received another request from the user, it sends a request to the voice server 3 via HTTP with a specified URL at block 312. The engine 6 then retrieves the call flow document corresponding to the specified URL at block 313, and the process and continues from block 305. If no further request has been received and if the session is still active at block 310, then the process loops back to block 309. If no further request has been received from the voice browser 2 and the session has terminated, the process ends. The duration of the process is open-ended, in that essentially any number of requests can be received from the user and voice browser 2, depending on the type of call flow being accessed.

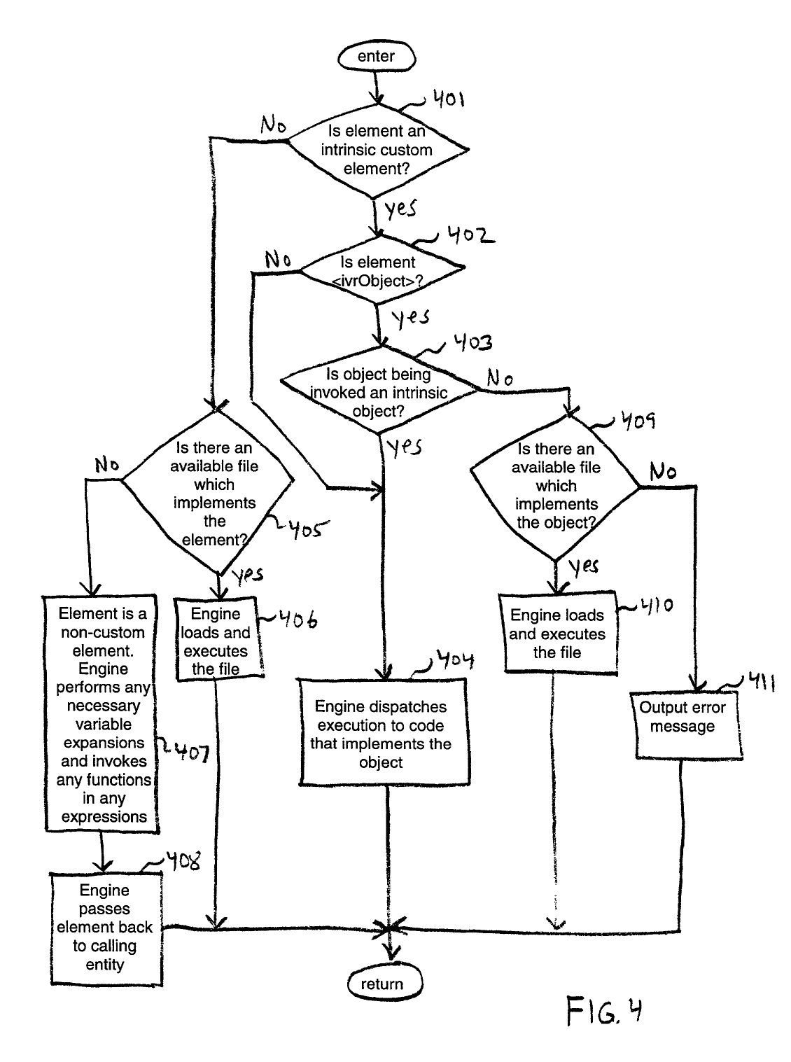

FIG. 4 shows the process of block 307 in greater detail, according to one embodiment. Upon entering the process, at block 401 the engine 6 determines whether the element currently being processed is an intrinsic (internal) custom element by consulting its table 34 of internal elements. If the element is an intrinsic custom element, then at block 402 the engine 6 next determines whether the element is the <ivrObject> tag (discussed below), which is used to incorporate an object into the call flow. If the element is the <ivrObject> tag, then the engine 6 determines at block 403 whether the object being invoked in the tag is an intrinsic (internal) object, by consulting its table 36 of internal objects.

If the object being invoked is an intrinsic object, the engine 6 dispatches execution to its internal code that implements the object at block 404, and the process then returns. The code which implements the object may be, for example, a script written in PHP, Perl, or C. Execution of the object may include, for example, one or more local computations, or it may cause the voice server to interact with one or more backend servers, if appropriate. The latter action can be accomplished by calling one or more application program interfaces (APIs). Execution of the object may also include the generation of additional VXML code by the engine 6, which is passed to the voice browser.

If the object is not an internal object, the engine 6 determines at block 409 if there is an external file available which implements the object. In one embodiment, external files are assigned names that match the name of the corresponding element, function or object used in the tag, to allow the engine 6 to easily locate the correct file. If there is such a file at block 409, then the engine 6 loads and executes the file at block 410, and the process then returns. The file may include a PHP, Perl or C script, for example, and execution may involve actions such as described above regarding block 404. If there is no such file, the engine 6 outputs an appropriate error message to the calling entity at block 411, and the process then returns.

If the element currently being processed is an intrinsic custom element but is determined not to be the <ivrObject> tag at block 402, then the process branches from block 402 to block 404 (discussed above).

If the element currently being processed is determined not to be an intrinsic custom element at block 401, then the process branches to block 405, in which the engine 6 determines if there is an external file available which implements the element. If there is such a file, then the engine 6 loads and executes the file at block 406, and the process then returns. The file may include a PHP, Perl or C script, for example, and execution may involve actions such as described above regarding block 404. If there is no such file found at block 405, then the element is determined not to be a custom element (i.e., it is a standard VXML element) at block 407. In that case, at block 407 the engine 6 performs any necessary variable expansions and invokes any functions that are represented in any expressions in the element, and then passes the element (or the result of block 407) back to the calling entity at block 408. The process then returns.

Of course, many variations upon the above-described process are possible within the scope of the present invention. For example, the sequence of operations can be altered and/or operations can be added or deleted while maintaining the essential nature of the process. One particular variation, which will now be described, is directed to improving the speed of execution of a call flow. The speed of execution will depend, at least in part, on the scripting language(s) employed and the particular version of the language(s). The above-described processes involve directly executing a requested call flow document by parsing it and calling the code which implements the custom elements in the document. This approach can be a time-consuming.

The following alternative process may be employed for overall faster performance. This process eliminates the need to parse a call flow document each time it is requested. The first time a call flow document is requested by the voice browser, the engine 6 parses the call flow document and outputs into a file all of the code needed to execute the call flow document (e.g., PHP code representing elements, functions and/or objects). The code may be located in the manner described above in connection with FIG. 4. The next time the call flow document is requested, however, if the document has not been modified since the file was generated, the engine 6 simply executes the code from the file. If the document has been modified since the file was generated, the engine 6 will regenerate the file from the modified document, and execute the call flow document.

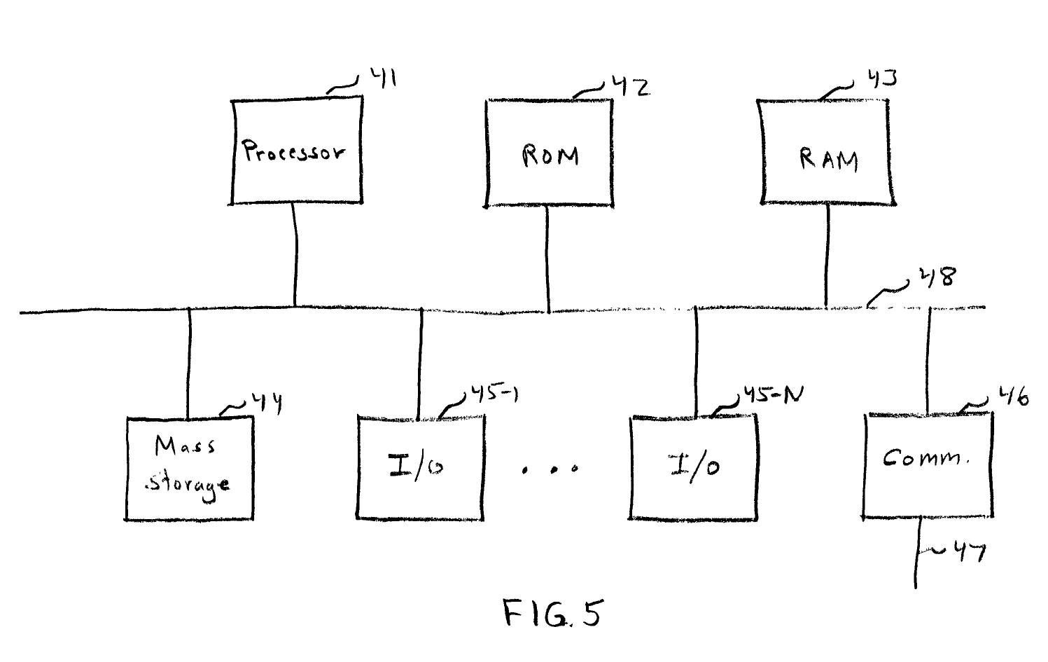

FIG. 5 is a block diagram showing an example of a processing system that can be used to implement any of the elements shown in FIG. 1. Note that FIG. 5 is not intended to represent any one specific physical arrangement of components, as such details are not germane to the present invention and are well within the knowledge of those skilled in the art. In addition, note that the elements shown in FIG. 1 may be distributed among two or more such processing systems, which may be connected to each other on a network or on an internetwork. The network or internetwork may be or may include, for example, a local area network (LAN), a wide area network (WAN), an corporate intranet, or the Internet, or a combination thereof. Each such physical machine may be, for example, a conventional personal computer (PC) or server-class computer. Note that the audio I/O interface 1 may also be implemented in a computer, as opposed to a conventional telephone; in that case, the computer might be a personal digital assistant (FDA) or any other type of computing device.

The processing system shown in FIG. 5 includes a processor 41, read-only memory (ROM) 42, and random access memory (RAM) 43, each connected to a bus system 48. The processor 41 may be or may include a general-purpose programmable microprocessor, for example. The bus system 48 may include one or more buses connected to each other through various bridges, controllers and/or adapters, such as are well-known in the art. For example, the bus system 48 may include a “system bus” that is connected through an adapter to one or more expansion buses, such as a peripheral component interconnect (PCI) bus or an extended industry standard architecture (EISA) bus. Also coupled to the bus system 48 are a mass storage device 44, a number of input/output (I/O) devices 45-1 through 45-N, and a data communication device 46. Examples of what I/O devices 45 might include are a keyboard, a pointing device (e.g., mouse, touchpad or trackball), a display device, and an audio speaker.

Mass storage device 44 includes a storage medium suitable for storing large volumes of data in a non-volatile manner, such as a magnetic disk or tape, magneto-optical (MO) storage device, or any of various types of Digital Versatile Disk (DVD) or Compact Disk (CD) based storage. Data communication device 46 provides data communication between the illustrated processing system and one or more other (possibly remote) processing systems over a communications link 47. Hence, data communication device 46 may be, for example, a conventional telephone modem, an Integrated Services Digital Network (ISDN) adapter, a Digital Subscriber Line (DSL) modem, a cable modem, a satellite transceiver, an Ethernet adapter, or a combination thereof.

Of course, many variations upon the architecture shown in FIG. 5 can be made to suit the needs of a particular machine. Thus, certain components may be added to those shown in FIG. 5 for a particular machine, or certain components shown in FIG. 5 may be omitted from a particular machine. For example, a server such as the voice server or backend servers does not necessarily require I/O devices designed to interface directly with a user, such as a keyboard, a pointing device, and a display device.

### III. VXML Extension Elements

The VXML extension elements (tags) will now be described in greater detail. First, each extension element will be briefly described, by category. A more complete description is given below (see section “VII”). Of course, additional extension elements may be defined, even after deployment of a system; in fact, the solution described herein facilitates the creation of new extension elements by those who maintain and operate IVR systems.

A. Document Structure

The following extension elements relate to document structure:

ivrCallFlow—This is the topmost element in a call flow document. It identifies the name of the call flow, as well as the first page in the call flow.

ivrPage—Defines a page, in which all other tags will be contained.

ivrExternalPage—Defines an external page. The file containing the page will be read when an attempt is made to execute the page.

ivrBlock—Used to group statements together into a block. The main use for ivrBlock is to enclose multiple tags in an include file into a single tag. Other uses are to help organize multiple statements, such as all the tags belonging to an <ivrElse/> tag.

ivrInclude—Includes the specified file. The pathname is relative to the callflows directory. The file will not be included until the ivrInclude tag is executed.

B. Control Flow

The following extension elements relate to control flow:

ivrIf, ivrElseIf, and ivrElse—Implement conditional control flow much like conventional if/then/else programming language construct.

ivrSwitch, ivrCase, and ivrDefault—implements a switch-like construct. The expression in the ivrSwitch tag is evaluated once, and then compared to each expression in the ivrCase tags until the two are equal. If they are equal, then any tags up to the next ivrCase, ivrDefault, or ivrSwitch tags are executed. If none of the ivrCase expressions matches and there is an ivrDefault tag, any tags after that tag will be executed.

ivrForEach—Enumerates over each element in an array. Sets local variable {variable}_key and {variable}_val for each key and value. expr should be a PHP expression that evaluates to an array.

ivrGotoFlow—Updates session data and emits a <goto> tag that starts executing the specified call flow. Also places the session id in the URL, as well as the server name and port for server affinity.

ivrReturn—Stops processing any more tags on the current page. Useful when it is necessary to do checks at the start of page that might result in an error condition or a goto and one does not want the rest of the page executed and/or want to have to enclose the rest of the page in an <ivrElse/> tag.

C. Audio Output

The following extension elements relate to audio output:

ivrPrompt—Outputs VXML <audio> tags to play various ivr (interactive voice response) prompts. Deals with internationalization and localization issues by locating the localized prompt files or saying a number/date in the localized format.

ivrPhrase, ivrPhraseCond, and ivrPhraseValue—Plays a phrase by looking it up in the phrase file for the current locale. A phrase is either text-to-speech (TTS)-based or based on static prompts. ivrPhraseValue's are used to set phrase variables, and ivrPhraseCond's are used to set phrase conditions.

D. Events

The following extension elements relate to events:

ivrNoInput—Used to implement a consistent VXML “no input” handler policy

ivrNoMatch—Used to implement a consistent VXML “no match” handler policy

E. Miscellaneous

Other extension elements include the following:\

ivrDtmfDigits—Used to specify fixed length digits DTMF grammar in a portable way

ivrVar—When used within the scope of an <ivrPage> tag, sets a variable which lasts for the duration of a page. That variable will override any ivrVar set in a call flow, or any PHP global variable (such as a URL query parameter). When used within the scope of an <ivrVars> tag, sets a variable that can be accessed within any <ivrPage>. The value can either be a “value” or an “expr”. An “expr” is evaluated, while a “value” is not.

ivrObject—Invokes an “object”, and passes parameters to it. The value of a parameter can either be a “value” or an “expr”. An “expr” is evaluated, while a “value” is not.

### IV. Call Flow Documents

Examples will now be described of call flow documents which include the above-mentioned VXML extension elements and which illustrate the manner of their use.

A. Top Level Call Flow

The following is an example of an extended VXML file which may be used to specify the top level call flow. It contains some global variables which are used throughout the call flow. It also contains references to the pages which are a part of the call flow. The system uses the <ivrExternalPage> tag to only load pages when they are accessed—thus it is a declaration mechanism which is used to optimize the parsing of the call flow.

[image]

[image]

B. Main Page

The main page is the first page that is loaded by the engine. It determines the account which should be accessed based on various phone number information and dispatches accordingly. For the purposes of this example, it is assumed that a “regular” account is being accessed and the user is being taken to the message drop-off page (described below).

[image]

[image]

[image]

[image]

[image]

[image]

[image]

[image]

[image]

[image]

[image]

[image]

[image]

[image]

[image]

[image]

[image]

[image]

### VI. Functions and Objects

As noted above, the solution described herein provides a set of objects and functions accessible from the call flow language, that provide application logic for call flows (e.g., playing a folder summary of new emails, faxes, and voicemails) and that also export the ability to access key system functionality, such as account profile information, voice mail messages, personal information management data (e.g. calendar and address book). The set of functions and objects is easily extensible, such that new functions and objects can be added on-the-fly. The following description describes examples of these functions and objects.

A. Functions

The following functions are examples of functions which may be included in the described system. Of course, additional functions can be defined, and these functions can be added to the system on-the-fly. For each function described below, the function name, syntax, and description of the function are given, along with any applicable restrictions, and where appropriate, examples of usage.

name: ivrSetFolder

syntax: ivrSetFolder($newFolder)

description: changes the current folder to the specified folder

restrictions: can only be called after ivrLogin has returned success

returns: 1 on success, 0 on error

example:

<ivrIf cond=“ivrSetFolder(‘${folder}’)”>

. . .

</ivrIf>

name: ivrLoadFolderList

syntax: ivrLoadFolderList( )

description: can be called to explicitly load the folder list. The folder list also gets loaded when calling ivrFolderCount( ) and ivrGetFolders( ).

restrictions: can only be called after ivrLogin has returned success

returns: 1 on success, 0 on error

name: ivrFolderCount

syntax: ivrFolderCount( )

description: returns the number of folders a user has

restrictions: can only be called after ivrLogin has returned success

returns: number of folders on success, 0 on error.

name: ivrGetFolders

syntax: ivrGetFolders($offset=0, $max=0)

description: returns a list of folder names, starting at the specified offset. Returns at most $max number of folders, or all if $max is 0. When offset is 0, INBOX and Trash will always be the first two folders in the list.

restrictions: can only be called after ivrLogin has returned success

returns: the list of folder names

name: ivrUrlEncode

syntax: ivrUrlEncode($string)

description: url encodes the input string

restrictions: none

returns: the url-encoded string

name: ivrFolder

syntax: ivrFolder( )

description: returns the current folder, which is initially INBOX after a successful login.

restrictions: can only be called after ivrLogin has returned success

returns: the current folder name

examples:

name: ivrInTrash

syntax: ivrInTrash( )

description: shorthand for “IvrFolder( )==‘Trash’”.

restrictions: can only be called after ivrLogin has returned success

returns: 1 if the current folder is Trash, 0 otherwise.

examples:

name: ivrInInbox

syntax: ivrInInbox( )

description: shorthand for “IvrFolder( )==‘INBOX’”.

restrictions: can only be called after ivrLogin has returned success

returns: 1 if the current folder is INBOX, 0 otherwise.

examples:

name: ivrHasFeature

syntax: ivrHasFeature($features)

description: returns true if the specified feature(s) are present in the OW.IvrFeatures account attribute. Multiple features can be separated by commas, and an “!” can be used to check if the specified feature is not enabled.

restrictions: can only be called after ivrLogin has returned success

returns: 1 on success, 0 on error

examples:

<ivrIf cond=“ivrHasFeature(‘TTS,Email’)”>

. . .

</ivrIf>

<ivrIf cond=“ivrHasFeature(‘!TTS’)”>

. . .

</ivrIf>

name: ivrPref

syntax: ivrPref($param)

description: returns the value of the param contained within OW_p.IvrPrefs

restrictions: can only be called after either ivrLogin or ivrGetPhoneInfo has returned success

returns: value of attribute

examples: ivrPref(‘DateTime’)==‘Y’

name: ivrGetAttr

syntax: ivrGetAttr($attr, $param=″″, $default=″″)

description: returns the value of the specified attribute. If param is specified, only the specified parameter within the attribute is returned. If default is specified and the attribute is not set or ″″, then the value of default will be used.

restrictions: can only be called after either ivrLogin

returns: value of attribute

examples: ivrGetAttr(‘OW_p.IvrPrefs’, ‘DateTime’)==‘Y’ ivrGetAttr(‘TimeZone’)

name: ivrValidPin

syntax: ivrValidPin($pin)

description: returns true if $pin is a string of exactly 4 digits.

restrictions: can only be called after ivrLogin has returned success

returns: 1 if the pin is valid, 0 otherwise.

name: ivrLogin

syntax: ivrLogin($pin)

description: attempts to login to the back end.

restrictions: can only be called after the ivrGetPhoneStatus object has been called. If this function returns success, the pin has been verified and the user authenticated. The variable $LC will also be set to the user's locale.

returns: IvrLoginok on success, IvrLoginAuthError for a bad pin or non-existent account, and IvrLoginSystemError for a general system error.

name: ivrAutoLogin

syntax: ivrAutoLogin( )

description: attempts to auto-login to the back end. auto-login is only valid for phones that are directly assigned.

restrictions: can only be called after the ivrGetPhoneStatus object has been called. If this function returns success, the PIN has been verified and the user authenticated. The variable $LC will also be set to the user's locale.

returns: same values as ivrLogin

name: ivrChangePin

syntax: ivrChangePin($newPin)

description: changes the pin to $newPin

restrictions: can only be called after ivrLogin has returned success

returns: 1 on success, 0 on error

name: ivrSetDateTime

syntax: ivrSetDateTime($isOn)

description: turns the DateTime parameter on if $isOn is non-zero, otherwise turns it of.

restrictions: can only be called after ivrLogin has returned success

returns: 1 on success, 0 on error

name: ivrEmptyTrash

syntax: ivrEmptyTrash( )

description: empties the Trash folder

restrictions: can only be called after ivrLogin has returned success

returns: 1 on success, 0 on error

name: ivrMailboxFull

syntax: ivrMailboxFull( )

description: returns true if the mailbox is full, i.e. the user is over quota

restrictions: can only be called after ivrLogin has returned success

returns: returns true if the mailbox is full

name: ivrSetGreeting

syntax: ivrSetGreeting($greeting_type, $greeting_id)

description: sets the greeting type to be used for the specified greeting_id. greeting_id is tied to particular phone numbers in the user's account, which can have different greetings. A greeting_id of “0” represents the default account greetings. greeting_type can be any of “standard”, “alternate”, “long”, “default” and “number”.

restrictions: can only be called after ivrLogin has returned success

returns: 1 on success, 0 on error

name: ivrGreetingUrl

syntax: ivrGreetingUrl($greeting_type, $greeting_id)

description: returns a (relative) URL that will return the audio for the specified greeting. See ivrSetGreeting( ) for a description of greeting_type and greeting_id.

returns: a relative URL for playing the specified greeting

name: ivrHasGreeting

syntax: ivrHasGreeting($greeting_type, $greeting_id)

description: returns true or false based on whether the user has a greeting of the specified type set for the specified greeting_id number. See ivrSetGreeting( ) for a description of greeting_type and greeting_id.

restrictions: can only be called after ivrLogin has returned success

returns: 1 if user has the specified greeting, 0 if not

name: ivrCheckedGreetings

syntax: ivrCheckedGreetings( )

description: keeps track of whether we have prompted the user to personalize their greetings during this session. If a user has no customized greetings we will remind him to set one up every time they log in.

restrictions: can only be called after ivrLogin has returned success

returns: 1 if check has already been done, 0 if not

name: ivrNeedsGreetings

syntax: ivrNeedsGreetings( )

description: checks to see whether the user has set up a standard default greeting. If a user has no customized greetings we will remind them to set one up every time they log in.

restrictions: can only be called after ivrLogin has returned success

returns: 1 if they have the standard greeting, 0 if not

name: ivrGreetingSave

syntax: ivrGreetingSave($greeting_type, $greeting_id)

description: sets the user's greeting for this greeting_id just as ivrSetGreeting( ) does, but will also store a newly recorded voice greeting, if it's available. The greeting audio is assumed to be available in the global “vm” form variable. See ivrSetGreeting( ) for a description of greeting_type and greeting_id.

restrictions: can only be called after ivrLogin has returned success

returns: 1 on success, 0 on failure

name: ivrHasMultipleNumbers

syntax: ivrHasMultipleNumbers( )

description: checks to see whether the user has multiple phone numbers of any type associated with their account.

restrictions: can only be called after ivrLogin has returned success

returns: 1 if they have multiple phone numbers, 0 if not

name: ivrListPhones

syntax: ivrListPhones( )

description: returns a list of the phone numbers associated with the current account. This will include both NANP and IDP numbers in canonical form, and will only return the first eight phone numbers if there are more.

restrictions: can only be called after ivrLogin has returned success

returns: a list of phone numbers in canonical form

name: ivrPhonePart

syntax: ivrPhonePart($phone_number)

description: $phone_number is either or NANP or IDP number in canonical form, and this will parse the number and return everything but the extension part.

returns: the string $phone_number minus the extension part

name: ivrExtPart

syntax: ivrExtPart($phone_number)

description: $phone_number is either or NANP or IDP number in canonical form, and this will parse the number and return only the extension part.

returns: just the extension part of $phone_number

name: ivrPhoneGid

syntax: ivrPhoneGid($phone_index)

description: $phone_index is the index into the list of the user's NANP and IDP phone numbers. This will return the greeting_id associated with the specified number. If the phone number does not currently have one, one will get assigned.

restrictions: can only be called after ivrLogin has returned success

returns: greeting_id of the corresponding phone number

name: ivrAddEmailRecipient

syntax: ivrAddEmailRecipient($addressbook_entry_index)

description: adds the email address from an entry in the user's address book to the list of recipients of the message he is about to send. The index refers to the index of the entry in the list of currently selected address book entries.

restrictions: can only be called after ivrLogin has returned success

returns: 1 if successful, 0 if the entry has no useable email address

name: ivrAddPhoneRecipient

syntax: ivrAddPhoneRecipient($phone_number, $extension)

description: looks up the provided phone number and extension in our system, and if it represents another user of the service, adds the email address of that user to the list of recipients of the message about to be sent. Returns an error if the provided phone number and extension don't represent another user of the service.

restrictions: can only be called after ivrLogin has returned success

returns: 1 on success, 0 if number is a user of the system

name: ivrNeedExtension

syntax: ivrNeedExtension($phone number_without_extension)

description: looks up the provided phone number in our system and determines whether it is a shared phone number and therefore an extension is needed to identify the associated user.

returns: 1 if an extension is needed, 0 if the number does not need an extension or the number is not in our system

name: ivrMsgMoreParts

syntax: ivrMsgMoreParts( )

description: while playing a particular message, checks to see if there are more message parts or chunks of TTS text to play.

restrictions: must be used in the context of playing back a particular message with ivrMsgContent object

returns: 1 if the message has more parts, 0 if not

name: ivrABSelectedCount

syntax: ivrABSelectedCount( )

description: returns the number of currently selected address book entries. Entries are selected with the ivrABMatches( ) function. If that function is not called first this function will just return the total number of address book entries.

restrictions: can only be called after ivrLogin has returned success

returns: number of selected address book entries

name: ivrAddressBookCount

syntax: ivrAddressBookCount( )

description: returns the total number of address book entries in the user's address book.

restrictions: can only be called after ivrLogin has returned success

returns: number of entries in the address book.

name: ivrGetABEntries

syntax: ivrGetABEntries($field, $offset=0, $max=0);

description: setting $field to “name” will return a list of address book entry identifying strings for TTS, anything else will return a list of the address book entry indexes, from the currently selected list of entries. It starts at the specified offset and returns at most $max number of entries, or all if $max is 0.

restrictions: can only be called after ivrLogin has returned success

returns: list of address book entry identifying strings or indexes into the currently selected list. The identifying string is intended for TTS playback of a list of entries, and is set to the first available fields from (FirstName,LastName) or the NickName, or the EmailAddress.

name: ivrABMatches

syntax: ivrABMatches($partial, $email_flag)

description: searches the user's address book for entries that match the dtmf digit string $partial as a prefix of any of the fields NickName, FirstName or LastName. $partial is turned into a regular expression based on the characters on the telephone keypad corresponding to the dtmf digits that were entered. For instance, the dtmf sequence “53” would get converted to the regular expression “ˆ [J-Lj-15][D-Fd-f3]” which would then be matched against the above fields in all address book entries.

Setting $email_flag to “1” will only match address book entries that have an EmailAddress defined. This is used when selecting recipients for sending messages.

The matching entries are stored in the session for subsequent address book operations, such as ivrGetABEntries and ivrABSelectedCount.

restrictions: can only be called after ivrLogin has returned success

returns: the number of matched address book entries, 0 if no matches and −1 if $email_flag=1 and none of the otherwise matched entries had defined EmailAddress fields

name: ivrPhone

syntax: ivrPhone(‘attr’)

description: returns the specified attribute associated with the current phone.

restrictions: can only be called after the ivrGetPhoneInfo object has been called.

Valid attributes are:

‘IVR’

description: returns the flow type of the current phonenumber.

returns: the flow, which will be one of these contants:

IvrFlowOnebox

IvrFlowComverse

IvrFlowOctel

‘PrimaryType’

‘TargetType’

description: returns the primary/target type of a phone

returns: the phone type, which will be one of these constants:

IvrTypePoolDtmf

IvrTypePoolDid

IvrTypeDirect

IvrTypeTargetWireless

IvrTypeTargetForward

IvrTypeTargetPrompt

IvrTypeTargetPickup

IvrTypeUndefined

IvrTypeError

‘CallerCanonical’

‘PrimaryCanonical’

‘RdnCanonical’

‘PoolId’

‘ID’

name: ivrPhoneStatus

syntax: ivrPhoneStatus( )

description: returns the status of a phone

restrictions: can only be called after the ivrGetPhoneInfo object has been called.

returns: the phone number's status, which will be one of these constants:

IvrStatusAccountActive

IvrStatusNotInService

IvrStatusAccountMaintenance

IvrStatusNoSuchPhone

IvrStatusError

name: ivrGetMsg

syntax: ivrGetMsg( )

description: gets information about the current message from the backend server. should be called before any of the ivrMsg* functions are used.

restrictions: can only be called after the ivrOrderFolder object has been called

returns: one of the following constants:

IvrGetMsgOk—the message is ready

IvrGetMsgGone—the requested message no longer exists

IvrGetMsgEmpty—there are no messages in this folder

IvrGetMsgNoMore—there are no more messages in this folder

name: ivrFinishMsg

syntax: ivrFinishMsg($op)

description: finishes with the current message, so the next call to ivrGetMsg will operate on the next message

$op should be one of the following constants:

IvrMsgOpDelete—message was deleted

IvrMsgOpSave—message was saved

IvrMsgOpGone—message no longer exists or couldn't be played

IvrMsgOpSkip—message was skipped

restrictions: can only be called after ivrGetMsg

returns: 1 on success, 0 on error

name: ivrDeleteMsg

syntax: ivrDeleteMsg( )

description: deletes the current message

restrictions: can only be called after ivrGetMsg( )

returns: 1 on success, 0 on error

name: ivrMsgFirstTime

syntax: ivrMsgFirstTime( )

description: used to determine if this is the first time ivrGetMsg has been called on the current message.

restrictions: can only be called after ivrGetMsg( )

returns: if this is the first time we have called ivrGetMsg on the current message returns 1, otherwise returns 0.

example:

```
<ivrIf cond=“ivrMsgIsEmail() &amp;&amp; ivrMsgFirstTime()”>
  <ivrPrompt>tolistenmsgp1</ivrPrompt>
<ivrElse/>
  <ivrPrompt>toreplayp1</ivrPrompt>
</ivrIf>
```

name: ivrFolderFirstMsg

syntax: ivrFolderFirstMsg( )

description: returns 1 if this is the first message in the folder

restrictions: can only be called after ivrGetMsg( )

returns: returns 1 if this is the first message in the folder

name: ivrMsgSendUrl

syntax: ivrMsgSendUrl($page)

description: returns a URL that when used in a <goto> will result in the current message being sent/forwarded/replied to.

restrictions: can only be called after ivrGetMsg

returns: a URL

name: ivrMsgContentUrl

syntax: ivrMsgContentUrl( )

description: returns a URL suitable for use in an <audio> tag that will play the current message

restrictions: can only be called after ivrLogin has returned success

returns: a URL

example:

<audio caching=“safe” src=“${{ivrMsgContentUrl( )}}”//>

name: ivrMsgSeen

syntax: ivrMsgSeen( )

description: returns 1 if the current message has been seen

restrictions: can only be called after ivrGetMsg has been called

name: ivrMsgCanReply

syntax: ivrMsgCanReply( )

description: returns 1 if user is allowed to reply to the current message (i.e., its not from a system account)

restrictions: can only be called after ivrGetMsg has been called

name: ivrMsgIsFax

syntax: ivrMsgIsFax( )

description: returns 1 if the current message is a fax message

restrictions: can only be called after ivrGetMsg has been called

name: ivrMsgIsVoice

syntax: ivrMsgVoice( )

description: returns 1 if the current message is a voice message

restrictions: can only be called after ivrGetMsg has been called

name: ivrMsgIsEmail

syntax: ivrMsgIsEmail( )

description: returns 1 if the current message is an email message

restrictions: can only be called after ivrGetMsg has been called

name: ivrFolderOrderType

syntax: ivrFolderorderType( )

description: returns the type passed into the ivrOrderFolder object (i.e., ‘e’,‘f’,‘v’).

restrictions: can only be called after the ivrOrderFolder object has been called

name: ivrMsgOpUrl

syntax: ivrMsgOpUrl($page, $op)

description: used to generate a URL that can be used in a <choice> or <goto>tag. $page should be set to the page that handles operations, and $op should be one of the following constants:

IvrMsgOpDelete—delete the current message

IvrMsgOpEnv—play the message envelope

IvrMsgOpGone—current message no longer exists

IvrMsgOpSave—save the current message

IvrMsgOpSkip—skip the current message

restrictions: can only be called after ivrGetMsg has been called

returns: a URL

example:

<choice dtmf=“2” next=“${{ivrMsgOpUrl(‘messages’, IvrMsgOpSave)}}”/>

name: ivr

syntax: ivr

description:

restrictions: can only be called after ivrLogin has returned success returns: 1 on success, 0 on error

name: ivrGetAppts

syntax: ivrGetAppts($date)

description: loads the calendar apppointment list for a given date (MMDDYY format)

restrictions: can be called only after ivrLogin has returned success

returns: 1 if appointment list retrieved successfully, 0 on error

example:

<ivrVar name=“apptCount” expr=“ivrGetAppts(‘040201’)”/>

name: ivrGetApptsCount

syntax: ivrGetApptsCount( )

description: retrieves the count of the the number of appointments for the appointment list last loaded by ivrGetAppts( )

restrictions: can be called only after ivrGetAppts has returned success

returns: a count of the number of appointments. It will return 0 if no appointments were found.

example:

<ivrVar name=“apptCount” expr=“ivrGetApptsCount( )”/>

name: ivrGetApptList

syntax: ivrGetApptList($apptsPerPage, $page)

description: retrieves an array of appointments for the appointment list last loaded by ivrGetAppts( )

restrictions: can be called only after ivrGetAppts has returned success

returns: returns an array of appointment information. The value at each index is a delimited string of the format:

{apptid};{allday};{starttime};{recurrenceID}.

The delimiter is not necessarily a semicolon. It is defined by IvrCalDelim

example:

<ivrForEach var=“appt” expr=“ivrGetApptList(5, 0)”>

// you can now act upon the array returned by ivrGetApptList

//the keys and values are accessed by ${appt_key} and

// ${appt_val} respectively

//See calApptList.pg for full example

</ivrForEach>

name: ivrGetTasks

syntax: ivrGetTasks($date)

description: loads the tasks due for a given date (MMDDYY format)

restrictions: can be called only after ivrLogin has returned success

returns: 1 if tasks retrieved successfully, 0 if error

example:

<ivrVar name=“taskCount” expr=“ivrGetTasks(‘040201’)”/>

name: ivrGetTasksCount

syntax: ivrGetTasksCount( )

description: retrieves the count of the task due for last date of tasks loaded by ivrGetTasks( )

restrictions: can be called only after ivrGetTasks has returned success

returns: a count of the number of tasks due. It will return 0 if no tasks were found or an error has occurred.

example:

<ivrVar name=“taskCount” expr=“ivrGetTasksCount( )”/>

name: ivrGetTaskList

syntax: ivrGetTaskList( )

description: retrieves an array of tasks due for last date of tasks loaded by ivrGetTasks( )

restrictions: can be called only after ivrGetTasks has returned success

returns: returns an array of tasks information. The value at each index is a delimited string of the format {datedue};{summary};{description The delimiter is not necessarily a semicolon. It is defined by IvrCalDelim

example:

<ivrForEach var=“task” expr=“ivrGetTasktList( )”>

//you can now act upon the array returned by ivrGetTaskList

//the keys and values are accessed by ${task_key} and

// ${task_val} respectively

//See calTaskList.pg for full example

</ivrForEach>

name: ivrGetApptInfo

syntax: ivrGetApptInfo($apptid, $recurid)

description: retrieves information about an appointment. I probably could have written this function so that information is loaded to state, but to stay consistent with the way appointment information retrieved for appointments in a list, I did it this way.

restrictions: can be called only after ivrGetTasks has returned success

returns: a delimited string of the following format:

{apptid};{allday};{starttime};{endtime};{subject};{location};{description};{recurrenc eID}

The delimiter is not necessarily a semicolon. It is defined by IvrCalDelim

example:

<ivrVar name=“apptInfo” expr=“ivrGetApptlnfo(‘${apptid}’,‘${recurid}’)”/>

name: ivrGetTodayDate

syntax: ivrGetTodayDate( )

description: gets the current date

restrictions: none

returns: date string in the format MMDDYY

example:

<ivrVar name=“today” expr=“ivrGetTodayDate( )”/>

name: ivrGetTomorrowDate

syntax: ivrGetTomorrowDate( )

description: gets tomorrow's date

restrictions: none

returns: date string in the format MMDDYY

example:

<ivrVar name=“tomorrow” expr=“ivrGetTomorrowDate( )”/>

name: ivrMoreAppts

syntax:ivrMoreAppts($apptcount, $page, $apptperpage)

description: checks if there are additional appointments for the currently loaded day that could not be displayed on the current page.

restrictions: can be called only after ivrGetAppts has returned success

returns: 1 if yes, 0 if no

example:

If you have 7 appointments ($apptcount) for a given day, and you display 5 appointments per per page ($apptperpage), then to check if the second page ($page) has any appointments, you would use:

<ivrIf cond=“ivrMoreAppts(7,1,5)”>

. . .

</ivrIf>

Note that the $page value starts the count from 0.

Page 1 is 0. Page 2 is 1. And so on.

name: ivrGetApptID

syntax: ivrGetApptID($apptinfo)

description: retrieves the appointment id given a delimited string containing appointment information (see ivrGetApptList for format). The delimiter is defined by IvrCalDelim

restrictions: none

returns: appointment ID string

example:

<ivrVar name=“id” expr=“ivrGetApptID(‘${apptInfo}’)”/>

name: ivrGetRecurID

syntax: ivrGetRecurID($apptinfo)

description: retrieves the recurrence id given a delimited string containing appointment information (see ivrGetApptList for format). This value will be an empty string if the appointment is not a recurring appointment.

The delimiter is defined by IvrCalDelim

restrictions: none

returns: appointment ID string

example:

<ivrVar name=“recurid” expr=“ivrGetRecurID(‘${apptInfo}’)”/>

name: ivrIsAllDay

syntax: ivrIsAllDay($apptinfo)

description: retrieves whether of not an appointment is all day given a delimited string containing appointment information

(see ivrGetApptList for format)

The delimiter is defined by IvrCalDelim

restrictions: none

returns: 1 if all day, 0 if not

example:

<ivrVar name=“allday” expr=“ivrIsAllDay(‘${apptInfo}’)”/>

name: ivrGetApptStartTime

syntax: ivrGetApptStartTime($apptinfo)

description: retrieves the appointment start time given a delimited string containing appointment information (see ivrGetApptList for format) The delimiter is defined by IvrCalDelim

restrictions: none

returns: the start time string in format YYYYMMDDTHHMMSS

example:

<ivrVar name=“starttime” expr=“ivrGetApptStartTime(‘${apptInfo}’)”/>

name: ivrGetApptEndTime

syntax: ivrGetApptEndTime($apptinfo)

description: retrieves the appointment end time given a delimited string containing appointment information (see ivrGetApptlnfo for format) The delimiter is defined by IvrCalDelim

restrictions: none

returns: the end time string in format YYYYMMDDTHHMMSS example:

<ivrVar name=“endtime” expr=“ivrGetApptEndTime(‘${apptInfo}’)”/>

name: ivrGetApptSubject

syntax: ivrGetApptSubject($apptinfo)

description: retrieves the appointment subject given a delimited string containing appointment information (see ivrGetApptlnfo for format) The delimiter is defined by IvrCalDelim

restrictions: none

returns: the subject string

example:

<ivrVar name=“subject” expr=“ivrGetApptSubject(‘${apptInfo}’)”/>

name: ivrGetApptLocation

syntax: ivrGetApptLocation($apptinfo)

description: retrieves the appointment location given a delimited string containing appointment information (see ivrGetApptlnfo for format) The delimiter is defined by IvrCalDelim

restrictions: none

returns: the location string

example:

<ivrVar name=“location” expr=“ivrGetApptLocation(‘${apptInfo}’)”/>

name: ivrGetApptDescription

syntax: ivrGetApptDescription($apptinfo)

description: retrieves the appointment description given a delimited string containing appointment information (see ivrGetApptlnfo for format) The delimiter is defined by IvrCalDelim

restrictions: none

returns: the description string

example:

<ivrVar name=“description” expr=“ivrGetApptDescription(‘${apptInfo}’)”/>

name: ivrGetTaskDueDate

syntax: ivrGetTaskDueDate($taskinfo)

description: retrieves the task due date given a delimited string containing task information (see ivrGetTaskList for format) The delimiter is defined by IvrCalDelim

restrictions: none

returns: due date string in format YYYYMMDDTHHMMSS

example:

<ivrVar name=“description” expr=“ivrGetTaskDueDate(‘${task_val}’)”/>

name: ivrGetTaskSummary

syntax: ivrGetTaskSummary($taskinfo)

description: retrieves the task summary given a delimited string containing task information (see ivrGetTaskList for format) The delimiter is defined by IvrCalDelim

restrictions: none

returns: task summary string

example:

<ivrVar name=“summary” expr=“ivrGetTaskSummary(‘${task_val}’)”/>

name: ivrGetTaskDescription

syntax: ivrGetTaskDescription($taskinfo)

description: retrieves the task description given a delimited string containing task information (see ivrGetTaskList for format) The delimiter is defined by IvrCalDelim

restrictions: none

returns: task description string

example:

<ivrVar name=“description” expr=“ivrGetTaskDescription(‘${task_val}’)”/>

name: ivrCalDate

syntax: ivrCalDate($tz, $tstr, $df=DateFmt_dateFull)

description: takes a timezone ($tz, eg “PST8PDT”), and a time string ($tstr, YYYYMMDDTHHMMSSZ), and a date format parameter (DateFmt_dateFull—default, DateFmt_dateTimeOnly, DateFmt_dateNoTime)

restrictions: none

returns: a friendly sounding version of the date.

example:

<ivrVar name=“friendlydate” expr=“ivrCalDate(‘PST8PDT’, ‘20010419T060000Z’, DateFmt_dateFull)”/>

The friendlydate variable will now have the value “06/19/2001 06:00 AM”

name: ivrGetStandardDate

syntax: ivrGetStandardDate($nsdate)

description: Takes a date value in the format (MMDDYY) and converts it into a more standard format

restrictions: none

returns: a date value in the format (YYYYMMDDT000000Z)

example:

<ivrVar name=“standarddate” expr=“ivrGetStandardDate(‘042401’)”/>

The standarddate variable now has the value “20010424T000000Z”

name: ivrIsValidDate

syntax: ivrIsValidDate( )

description: checks if a date in the format (MMDDYY) is valid. For example, “150101” and “029901” are obviously not valid dates. It will also guard against the 29th of February if it does not exist for the specified year, etc.

restrictions: none

returns: “1” if it is a valid date. Otherwise “0”

example:

<ivrIf cond=“ivrIsValidDate(‘040512’)”>

. . .

</ivrIf>

name: ivrGetSSFEMsg

syntax: ivrGetSSFEMsg($callerid)

description: used as part of a WAPIVR session. If connecting from a WAP client to the IVR, the intent is to either listen to a message or record a reponse to the message. This function loads the message from the state server (SSFE).

restrictions: none

returns: 1 if success, 0 if error

example:

Use the following to check that the message is loaded successfully.

If so, act upon it.

<ivrIf cond=“ivrGetSSFEMsg(‘${callerid}’)”>

. . .

</ivrIf>

name: ivrGetSSFEMsgUID

syntax: ivrGetSSFEMsgUID( )

description: retrieves the message ID of the currently loaded IVRWAP message

restrictions: ivrGetSSFEMsg must return a success

returns: message id string

example:

<ivrVar name=“msguid” expr=“ivrGetSSFEMsgUID( )”/>

name: ivrGetSSFEMsgAction

syntax: ivrGetSSFEMsgAction( )

description: retrieves the message action of the currently loaded IVRWAP message

restrictions: ivrGetSSFEMsg must return a success

returns: “l” is listening to a message, “c” if recording a reply to a message

examples:

<ivrVar name=“msgaction” expr=“ivrGetSSFEMsgAction( )”/>

name: ivrIsWap

syntax: ivrIsWap( )

description: checks if the session was started from a WAP client

restrictions: initial session state information has to be written

returns: 1 if session started from WAP client, 0 otherwise.

example:

<ivrIf cond=“ivrIsWap( )”>

. . .

</ivrIf>

name: ivrVoicemailAppend

syntax: ivrVoicemailAppend($audioBody, $append)

description: if $append==1, appends $audioBody to session state if $append==0, sets $audioBody to session state

restrictions: Currently supports the audioBody in au or wav format.

returns: 1 if successful, 0 if failed.

name: ivrDropoffDeposit

syntax: ivrDropoffDeposit($pri=0)

description: delivers the voicemail previously buffered in session state (through ivrVoicemailAppend) to the recipient. (This is used in the “deposit message” callflow.

$pri is the priority of the message. 1 is for urgent, 0 is for normal.

returns: 1 if successful, 0 if failed.

name: ivrSendmsgDeposit

syntax: ivrSendmsgDeposit($action, $pri=0)

description: delivers the voicemail previously buffered in session state (through ivrVoicemailAppend) to the recipient. (This is used in the “send message” callflow).

$action is the action for the message. $action can be one of the following value:

“ra”: reply to all

“rs”: reply to sender

“fwd”: forward

$pri is the priority of the message. 1 is for urgent, 0 is for normal.

returns: 1 if successful, 0 if failed.

name: ivrFolderNumMsgs

syntax: ivrFolderNumMsgs($type=″″)

description: returns the number of messages in the current folder.

If $type is specified, only messages of those type are counted. If type is not specified, the total number of all messages in the folder is returned.

$type=‘e’ for email, ‘v’ for voice mail, and ‘f’ for faxes

restrictions: can only be called after ivrLogin has returned success example:

<ivrIf cond=“ivrFolderNumMsgs(‘v’)”>
<ivrPrompt>tolisttovm</ivrPrompt>
</ivrIf>

B. Objects

The following objects are examples of objects which may be included in the described system. Of course, additional objects can be defined, and these objects can be added to the system on-the-fly. For each objects described below, the object name, syntax, description and parameters of the object type are given, along with any applicable restrictions, and where appropriate, examples of usage.

name: ivrFolderSummary

syntax:

```
<ivrObject name=“ivrFolderSummary”>
  [<param name=“force” value=“1”/>]
  [<param name=“enable” value=“1”/>]
</ivrObject>
```

description: emits <audio> tags for the folder summary (you have 1 new voice . . . ). The tags are output if either the “force” param is set to “1”, or the previous call to ivrFolderSummary object had the “enable” param set to “1”.

restrictions: should be used only in a <prompt> tag, unless the the “enable” param is used.

parameters:

force=if set to 1, always play summary

enable=if set to 1 the next time ivrFolderSummary is called the summary will play once, and enable will be reset to 0.

examples:

1. This call enables the folder summary object so the next time it is called it will play a summary

<ivrObject name=“ivrFolderSummary”
<param name=“enable” value=“1”/>
</ivrObject>

2. This call will play the summary if the previous call to ivrFolderSummary was with “enable” set to “1”.

<prompt>
<ivrObject name=“ivrFolderSummary”/>
</prompt>

name: ivrGetPhoneStatus

syntax:

<ivrObject name=“ivrGetPhoneStatus”>
[<param name=“extension” value=“nnnn”/>]
</ivrObject>

description: Makes a call to the backend server to retrieve the status of the current phone number. Used with the ivrPhoneStatus( ) function.

restrictions: should only be called after the ivrGetPhoneInfo object has been called.

parameters:

extension=set to the extension if this number is associated with extensions.

examples:

1. Get the phone status for the current phone number.

```
<ivrObject name=“ivrGetPhoneStatus”/>
  <ivrSwitch expr=“ivrPhoneStatus()”>
  <ivrCase expr=“IvrStatusAccountActive”/>
    ...
  <ivrCase expr=“IvrStatusAccountMaintenance”/>
    ...
  </ivrSwitch>
```

2. Same as above, but shows how the extension is passed in. The extension is obtained by prompting the user to enter it.

```
<ivrObject name=“ivrGetPhoneStatus”>
  <param name=“extension” value=”${extension}”/>
</ivrObject>
<ivrSwitch expr=“ivrPhoneStatus()”>
  ...
</ivrSwitch>
```

name: ivrGetPhoneInfo

syntax:

```
<ivrObject name=“ivrGetPhoneInfo ”>
  [<param dnis=“extension” value=“nnnnnnnnnn”/>]
  [<param ani=“extension” value=“nnnnnnnnnn”/>]
  [<param rdnis=“extension” value=“nnnnnnnnnn”/>]
</ivrObject>
```

description: Makes a call to the backend server server to retrieve information about a phone number. Used with the ivrPhoneFlow and ivrPhonePrimaryType functions.

restrictions: should only be called once per session

parameters:

dnis=the terminating phone number

ani=caller-id of the caller

rdnis=the phone number that was originally called in the case of a redirect

examples:

1. the variables dnis/ani/rdnis are passed from the VXML browser using the variables session.telephone.ani, session.telephone.dnis, and session.telephone.rdnis. After calling ivrGetPhoneInfo, the ivrPhoneFlow function is used to determine the type of call flow to use for the session.

```
<ivrObject name=“ivrGetPhoneInfo”>
  <param name=“dnis” value=“${dnis}”/>
  <param name=“ani” value=“${ani:unknown}”/>
  <param name=“rdnis” value=“${rdnis:unknown}”/>
</ivrObject>
<ivrIf cond=“ivrPhoneFlow() == IvrFlowOnebox”>
  <ivrGotoFlow flow=“iso”/>
<ivrElse/>
  <ivrPrompt>systemdown</ivrPrompt>
<exit/>
```

name: ivrOrderFolder

syntax:

<ivrObject name=“ivrOrderFolder”>
[<param name=“type” value=“e|v|f”/>]
</ivrObject>

description: orders a folder for processing a particular type of message. The order is new urgent messages, followed by new messages, followed read messages. used in conjunction with the ivrGetMsg and ivrFinishMsg functions.

restrictions: should only be called at the start of process messages in a folder.

parameters:

type=‘e’ for email, ‘v’ for voice mail, and ‘f’ for faxes.

examples:

1. This orders the current folder for processing email messages.

<ivrObject name=“ivrOrderFolder”>
<param name=“type” value=“e”/>
</ivrObject>

name: ivrGreetingPrompts

syntax:

<ivrObject name=“ivrGreetingPrompts”>
[<param name=“mboxfull” value=“0|1”/>]
</ivrObject>

description: emits the <audio> tags for playing the greeting of the current phone number.

restrictions: should be used only within a <prompt> tag. should only be called after ivrGetPhoneInfo has been called.

parameters:

mboxfull=should be set to 1 if the mailbox is full

examples:

1. plays the greetings for the current phone number.

```
<prompt bargein=“true”>
  <ivrObject name=“ivrGreetingPrompts”>
    <param name=“mboxfull” expr=“ivrMailboxFull()”/>
  </ivrObject>
</prompt>
```

name: ivrAddrbookEntry

syntax:

<ivrObject name=“ivrAddrbookEntry”>
[<param name=“entryIndex” value=“nnn”/>]
</ivrObject>

description: emits <audio> tags for TTS of the specified address book entry

restrictions: should only be used in a <prompt> tag

parameters:

entryIndex=index into the currently selected entries from the user's address book

examples:

1. output the address book entry that the variable “abe” points to.

```
<prompt bargein=“true”>
  <ivrObject name=“ivrAddrbookEntry”>
    <param name=“entryIndex” value=“${abe}”/>
  </ivrObject>
</prompt>
```

name: ivrMsgStatusPrompt

syntax:

<ivrObject name=“ivrMsgStatusPrompt”/>

description: emits <audio>tags that describe the status of the current message. For example “first new email”, or “next deleted fax”.

restrictions: should only be used within a <prompt> tag, and only used after the ivrGetMsg( ) function has been called.

parameters: <none>

examples:

1. play the status of the current message

<prompt>
<ivrObject name=“ivrMsgStatusPrompt”/>
</prompt>

name: ivrMsgEnvelope

syntax:

<ivrObject name=“ivrMsgEnvelope”>

[<param name=“full” value=“0|1”/>]

</ivrObject>

description: emits <audio> tags that play message envelope information, such as the time received, the sender, etc.

restrictions: should only be used within a <prompt> tag, and only used after the ivrGetMsg( ) function has been called.

parameters:

full=set to 1 if the full envelope (which includes message duration for voice mail and number of pages for faxes) is to be played.

examples: play the message envelope.

```
<ivrVar name=“fullEnvelope” expr=“0”/>
...
<prompt>
  <ivrIf cond=“ivrDateTimeIsOn( )”>
  <ivrObject name=“ivrMsgEnvelope”>
    <param name=“full” expr=“${fullEnvelope}| |ivrMsgIsFax( )”/>
    </ivrObject>
  </ivrIf>
  </prompt>
```

name: ivrListenedToMsg

syntax:

<ivrObject name=“ivrListenedToMsg”/>

description: should be called if the user listened to the entire message.

restrictions: should only be used after ivrGetMsg( ) has been called to set the current message.

parameters: <none>

examples: This example shows the ivrListenedToMsg object being called if the “seen” variable is set to 1.

<ivrIf cond=“${seen}”>
<ivrObject name=“ivrListenedToMsg”/>
</ivrIf>

name: ivrInitSession

syntax:

<ivrObject name=“ivrInitSession”/>

description: initials a session. After calling this function, the global variable $SID is set to the session ID.

restrictions: <none>

parameters: <none>

examples: <ivrObject name=“ivrInitSession”/>

name: ivrEndSession

syntax:

```
<ivrObject name=“ivrEndSession”>
  [<param name=“event” value=“...”/>]
  [<param name=“subevent” value=“...”/>]
  [<param name=“info” value=“...”/>]
</ivrObject>
```

description: ends the current session

restrictions: should only be called after calling ivrInitSession

parameters:

event=vxml event, if one was thrown

subevent=openwave subevent if one was thrown

info=any extra textual information to log

name: ivrMsgContent

syntax:

<ivrObject name=“ivrMsgContent”>
[<param name=“reset” value=“”/>]
</ivrObject>

description: emits audio tags for playing the content of the current message, appropriate for the message type. Can either emit audio for the entire message all at once, or loop over the message and emit audio part-by-part. Also, if the part requires TTS, such as an email body, it can break the text up into chunks and loop over those over multiple requests. This behavior is controlled through configurable application options.

When looping over a message, the ivrMsgMoreParts( ) call can be used to determine whether there are more parts to be played.

restrictions: <restrictions>

parameters:

reset=if looping, set this to 1 to start over and replay the entire message from the beginning again.

example:

```
<ivrIf cond=“${playContent}”>
  <ivrObject name=“ivrMsgContent”>
    <param name=“reset” value=“${contentReset:1}”/>
  </ivrObject>
</ivrIf>
```

name: ivrInitializeSend

syntax:

<ivrObject name=“ivrInitializeSend”/>

description: Must be called before sending, forwarding or replying to a message, before beginning to select recipients. Session state is used to track selected users for sending messages, and calling this ensures that the session state is cleared of any previous entries.

restrictions: Must be called before beginning to select recipients for sending, forwarding or replying to a message,

parameters: <none>

name: ivrGotoFlow

syntax:

```
<ivrObject name=“ivrGotoFlow”>
  <param name=“flow” value=“...”/>
  [<param name=“page” value=“...”/>]
</ivrObject>
```

description: updates session data and emits a <goto> tag that starts executing the specified callflow. also places the session id in the URL, as well as the server name and port for server affinity.

restrictions: should only be used where a <goto> tag is allowed. should only be called after the ivrInitSession function has been called.

parameters:

flow=name of the flow

page=optional name of page within the specified flow to begin execution. If not specified, the page specified in the

<ivrCallFlow>“initial” attribute will be used.

examples:

1. Goto the iso call flow, and execute the page specified in the “initial” attribute of the <ivrCallFlow> tag.

<ivrObject name=“ivrGotoFlow”>
<param name=“flow” value=“iso”/>
</ivrObject>

2. Goto the “test” call flow, and execute the page named “hello”.

```
<ivrObject name=“ivrGotoFlow”>
  <param name=“flow” value=“test”/>
  <param name=“page” value=“hello”/>
</ivrObject>
```

expanded VXML:

The first example expands to:

<goto next=“http://{TOP}/ivr/sid-{SID}/engine?flow=iso”/>

Where {TOP} is the hostname and port of the webserver, and {SID} is the session id.

The second example expands to:

<goto next=“http://{TOP}/ivr/sid-{SID}/engine?flow=test&page=hello”/>

NOTE: The exact format of the URL is subject to change, but this tag will always result in a <goto . . . > tag being generated.

name: ivrDtmfDigits

syntax:

<ivrObject name=“ivrDtmfDigits”>
<param name=“length” value=“n”/>
</ivrObject>

where n is a positive integer.

description: Generates fixed length digits dtmf grammar.

restrictions: allowed anywhere a VXML <dtmf> tag is allowed.

attributes:

length=length of the digits.

example:

<ivrObject name=“ivrDtmfDigits”>
<param name=“length” value=“4”/>
</ivrObject>

expands to:

On VXML browsers that support builtin: grammers:

<dtmf src=“builtin:dtmf/digits?length=4”/>for VG

and on the Cisco VXML browsers it will generate:

<dtmf type=“regex”> . . . </dtmf>

name: <name>

syntax:

<ivrObject name=“”>
[<param name=“” value=“”/>]
</ivrObject>

description: <desc>

restrictions: <restrictions>

parameters: <none>

example: <ivrObject name=″″/>

Thus, a method and apparatus for using VXML extensions to incorporate application logic into a voice responsive system have been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative sense rather than a restrictive sense.

What is claimed is:

1. A method comprising:
creating a VXML based call flow document for use by a server in a voice responsive system to define a call flow, including incorporating a VXML extension element into the call flow document to provide application logic for the call flow; and
storing the call flow document in the voice responsive system.

2. A method as recited in claim 1, wherein the VXML extension element specifies application logic.

3. A method as recited in claim 2, wherein the a VXML extension element specifies a conditional control flow.

4. A method as recited in claim 1, wherein the VXML extension element specifies a logically separate executable entity that contains application logic.

5. A method as recited in claim 1, wherein said executing the application logic comprises invoking an application-level operation on a remote server as part of the call flow based on one of the VXML extension elements.

6. A method of providing a voice application, the method comprising:
receiving request from a voice browser;
in response to the request, parsing a call flow document, the call flow document including a plurality of predefined VXML extension elements to incorporate application logic into a call flow; and
executing the application logic based on the VXML extension elements.

7. A method as recited in claim 6, wherein the plurality of VXML extension elements include a VXML extension element specifying application logic.

8. A method as recited in claim 7, wherein the a VXML extension element specifies a conditional control flow.

9. A method as recited in claim 6, wherein the plurality of VXML extension elements include a VXML extension element specifying a logically separate entity that contains application logic.

10. A method as recited in claim 6, wherein said executing the application logic comprises invoking an application-level operation on a remote server as part of the call flow based on one of the VXML extension elements.

11. A method of executing a call flow in a voice responsive processing system, the method comprising:
accessing an XML based document in response to a request from a remote entity;
identifying a tag in the XML based document;
determining whether the tag is a predefined XML extension element; and
if the tag is a predefined XML extension element, then executing call flow logic corresponding to the tag.

12. A method as recited in claim 11, wherein the XML based document is a VXML based document, and the predefined XML extension element is a predefined VXML extension element.

13. A method as recited in claim 11, wherein the tag is a predefined XML extension element specifying call flow logic.

14. A method as recited in claim 13, wherein the tag specifies a conditional control flow.

15. A method as recited in claim 11, wherein the tag is a predefined XML extension element specifying a logically separate entity that contains call flow logic.

16. A method as recited in claim 11, wherein said executing call flow logic comprises invoking an application-level operation on a remote server as part of the call flow based on the tag.

17. A method of operating a server in a voice responsive processing system, the method comprising:
receiving a request at the voice server from a voice browser;
accessing a VXML based document in response to the request;
parsing the call flow document, including identifying a tag in the VXML document;
determining whether the tag is a standard VXML tag;
if the tag is a standard VXML tag, then outputting the tag to the voice browser;
if the tag is not a standard VXML tag, determining whether the tag is a predefined VXML extension element;
if the tag is a predefined VXML extension element, then executing call flow logic corresponding to the tag.

18. A method as recited in claim 17, wherein the tag is a predefined VXML extension element specifying call flow logic.

19. A method as recited in claim 18, wherein the tag specifies a conditional control flow.

20. A method as recited in claim 17, wherein the tag is a predefined VXML extension element specifying a logically separate entity that contains call flow logic.

21. A method as recited in claim 17, wherein said executing call flow logic comprises invoking an application-level operation on a remote server as part of the call flow based on the tag.

22. A processing system to execute a call flow, the processing system comprising:
a web server; and
an engine configured to interpret an XML document including a plurality of XML extension elements which incorporate logic into the call flow.

23. A processing system as recited in claim 22, wherein the document is a VXML based document, and the plurality of XML extension elements comprise a plurality of VXML extension elements.

24. A processing system as recited in claim 23, wherein the plurality of VXML extension elements comprises a predefined VXML tag specifying application logic.

25. A processing system as recited in claim 24, wherein the tag specifies a conditional control flow.

26. A processing system as recited in claim 23, wherein the plurality of VXML extension elements comprises a predefined VXML tag specifying a logically separate entity that contains application logic.

27. A processing system as recited in claim 23, wherein the plurality of VXML extension elements comprises a predefined VXML tag for invoking an application-level operation on a remote server as part of the call flow.

28. A voice server comprising:
a web server to respond to requests from a voice browser; and
an engine responsive to the web server to interpret a set of one or more VXML based call flow documents, the set of VXML based call flow documents including a plurality of predefined VXML extension elements, to incorporate logic into a call flow, the plurality of VXML extension elements including a first VXML tag defined to specify application logic, and a second VXML tag defined to reference a logically separate entity that specifies application logic.

29. A voice server as recited in claim 28, wherein the plurality of VXML extension elements includes a VXML extension element specifying execution of an application-level operation on a remote server as part of the call flow.

30. A voice server as recited in claim 28, wherein each of the plurality of VXML extension elements is capable of interaction with VXML code in which it is incorporated.

31. A voice server as recited in claim 28, wherein the first VXML tag specifies conditional control flow.

32. A voice server as recited in claim 28, wherein the second VXML tag specifies an object to be invoked as part of the call flow, the object including application logic.

33. A voice server as recited in claim 28, wherein the plurality of VXML extension elements includes a VXML extension element specifying a prompt to be played as part of the call flow.

34. A voice server as recited in claim 28, wherein the engine interpreting one of the plurality of VXML extension elements causes additional VXML code to be generated and provided to the voice browser via the VXML server in response to the request.

35. An apparatus comprising:
means for receiving request from a voice browser;
means for parsing a call flow document in response to the request, the call flow document including a plurality of predefined VXML extension elements to incorporate application logic into a call flow; and
means for executing the application logic based on the VXML extension elements.

36. An apparatus as recited in claim 35, wherein the plurality of VXML extension elements include a VXML extension element specifying application logic.

37. An apparatus as recited in claim 36, wherein the a VXML extension element specifies a conditional control flow.

38. An apparatus as recited in claim 35, wherein the plurality of VXML extension elements include a VXML extension element specifying a logically separate entity that contains application logic.

39. An apparatus as recited in claim 35, wherein the means for executing the application logic comprises means for invoking an application-level operation on a remote server as part of the call flow based on one of the VXML extension elements.

40. A machine-readable storage medium storing a VXML based call flow document for use by a server in a voice responsive system to define a call flow, the call flow document including a VXML extension element to provide application logic for the call flow.

41. A machine-readable storage medium as recited in claim 40, wherein the VXML extension element specifies application logic.

42. A machine-readable storage medium as recited in claim 41, wherein the a VXML extension element specifies a conditional control flow.

43. A machine-readable storage medium as recited in claim 40, wherein the VXML extension element specifies a logically separate executable entity that contains application logic.

44. A machine-readable storage medium as recited in claim 40, wherein said executing the application logic comprises invoking an application-level operation on a remote server as part of the call flow based on one of the VXML extension elements.

45. A method of modifying a call flow, the method comprising:
storing a VXML based call flow document for use by a server in a voice responsive system, the call flow document defining a call flow and including a set of VXML extension elements for providing application logic for the call flow; and
modifying the call flow by modifying the stored call flow document in the voice responsive system while the voice responsive system is in operation.

46. A method as recited in claim 45, wherein said modifying comprises adding, deleting or modifying a VXML extension element in the call flow document.
